(19) United States
(12) Patent Application Publication
(10) Pub. No.: US 2010/0260957 A1
(43) Pub. Date: Oct. 14, 2010

(54) PROTECTING COVER FOR BICYCLE CONTROL LINE

(75) Inventor: Sheng-Zhang Xie, Changhua (TW)

Correspondence Address: RABIN & Berdo, PC, 1101 14TH STREET, NW, SUITE 500, WASHINGTON, DC, 20005, US

(73) Assignee: CHIEH YU TE ENTERPRISE CO., LTD., Changhua (TW)

(21) Appl. No.: 12/421,642

(22) Filed: Apr. 10, 2009

(51) Int. Cl. B32B 1/08

(52) U.S. Cl. 428/36.91

(57) ABSTRACT

A protecting cover for a bicycle control line includes an inner capsule and an outer capsule covering the control lines in a same section of a bicycle body. The inner capsule is made of a hard plastic material and in a hollow passage form, and has a plurality of protrusions disposed on an external circumferential surface of the inner capsule. The outer capsule is made of a soft material and in a hollow passage form and has a plurality of penetrating holes disposed at positions corresponding to the protrusions on an external circumferential surface of the inner capsule. The inner capsule covers a section of brake or speed change control lines in contact with the bicycle body. The flexible outer capsule covers the inner capsule, and the protrusions at the external surface of the inner capsule are embedded into the penetrating hole of the outer capsule, so as to protect the bicycle body from being scratched or damaged by the contact of the control line.

### BACKGROUND OF THE INVENTION

1. Field of the Invention

The present invention relates to a protecting cover for a bicycle control line, and more particularly to a protecting cover composed of an inner capsule and an outer capsule and wrapped onto a bicycle body for protecting the bicycle body from being contacted and scratched by the control lines of a brake and a speed change in the same section.

2. Description of the Related Art

Bicycle control line B is simply a device provided for riders to operate the brake and control the brake and speed change functions of a wheel A1 to drive a bicycle body A to move forward or backward, wherein the control line B starts from both sides of a handlebar A2 held by both hands of the riders, and runs along a front fork tube A3 and a bicycle body frame A4 of the bicycle body A (as shown in FIGS. 1 and 2), and connects with a brake device and a speed change device. A retainer A5 is provided for passing and positioning the control line B to prevent the control line from wobbling. Regardless of the control line B of a brake device or the control line B of a speed change device, the control line B is in contact with the bicycle body A. Even though the contact area is small, a worn-out A6 is produced at the contact position of the control line B and the bicycle body A after a period of time, and the worn-out A6 will damage the overall appearance of the bicycle body. After the use for a long time, the contact section of the control line B will be scratched and damaged.

### SUMMARY OF THE INVENTION

In view of the aforementioned shortcomings of the prior art, the inventor of the present invention designed and developed a protecting cover for bicycle control, wherein an inner capsule and an outer capsule are wrapped around the same section where the control lines of a brake device and a speed change device are in contact with a bicycle body for protecting the bicycle body from being scratched or damaged by the contact of the control line.

Therefore, it is a primary objective of the present invention to provide a protecting cover for a bicycle control line, wherein the inner capsule is made of a hard plastic material and in a hollow passage form and a plurality of protrusions are formed on an external circumferential surface of the inner capsule.

Another objective of the present invention is to provide a protecting cover for a bicycle control line, wherein the outer capsule is made of a soft material and in a hollow passage form and a plurality of penetrating holes are disposed on an external circumferential surface of the outer capsule. With an effect of the flexibility, the control line will no longer scratch or damage the bicycle body after the protecting cover is applied.

Another objective of the present invention is to provide a protecting cover for a bicycle control line, wherein the inner and outer capsules have protrusions and penetrating holes disposed on their external surfaces and engaged with each other to provide a positioning effect.

Another objective of the present invention is to provide a protecting cover for a bicycle control line, wherein the inner and outer capsules have protrusions and penetrating holes disposed on their external surfaces and aligned at position corresponding to each other to engage the inner and outer capsules.

Another objective of the present invention is to provide a protecting cover for a bicycle control line, wherein the inner and outer capsules have protrusions and penetrating holes disposed on their external surfaces and designed in corresponding shapes to engage the inner and outer capsules.

### BRIEF DESCRIPTION OF THE DRAWINGS

FIG. 1 is a schematic view of a prior art;

FIG. 2 is a schematic view of another prior art;

FIG. 3A is a schematic view of an inner capsule of the invention;

FIG. 3B is a cross-sectional view of an inner capsule of the invention;

FIG. 4A is a schematic view of an outer capsule of the invention;

FIG. 4B is a cross-sectional view of an outer capsule of the invention;

FIG. 5 is a schematic view of assembling a protecting cover of the invention;

FIG. 6 is another schematic view of an assembling a protecting cover of the invention;

FIG. 7 is a cross-sectional view of an assembled protecting cover of the invention;

FIG. 8 is another cross-sectional view of an assembling a protecting cover of the invention;

FIG. 9 is a schematic view of a preferred embodiment of the invention; and

FIG. 10 is another schematic view of a preferred embodiment of the invention.

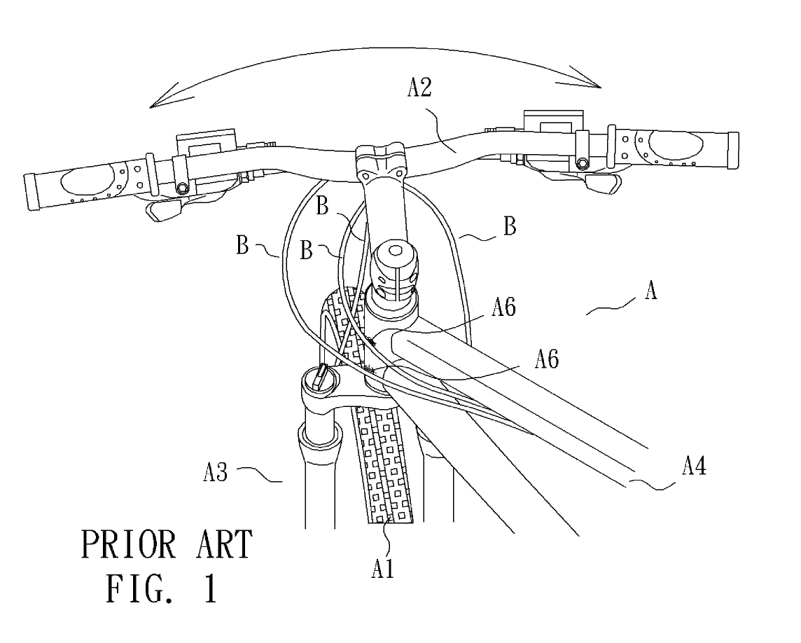

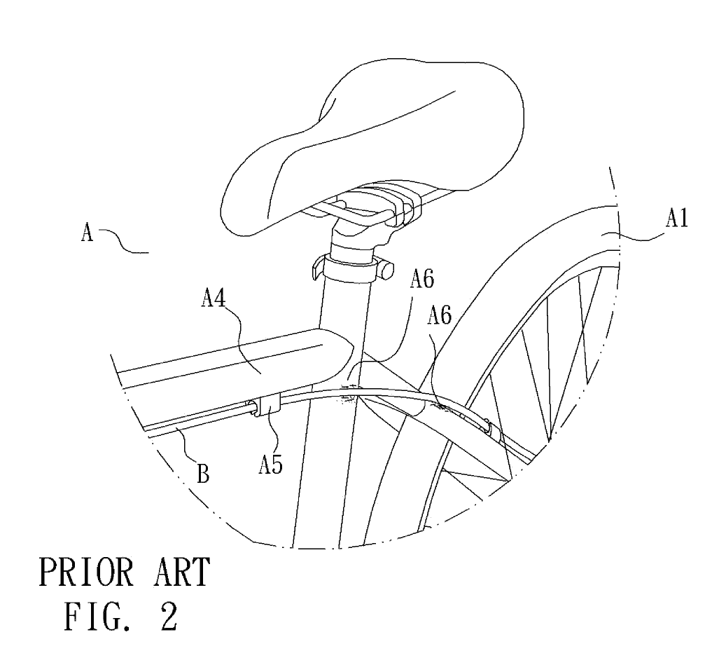

### DETAILED DESCRIPTION OF THE PREFERRED EMBODIMENTS

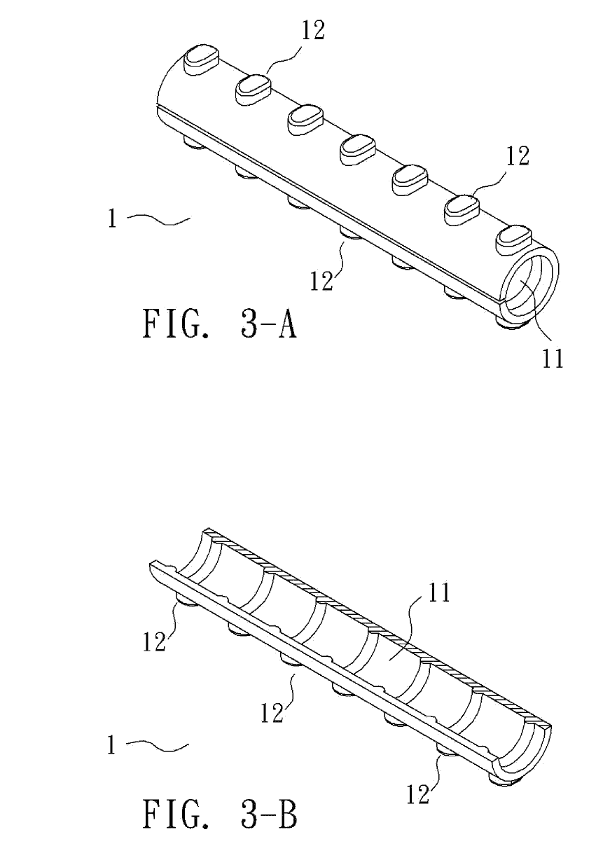

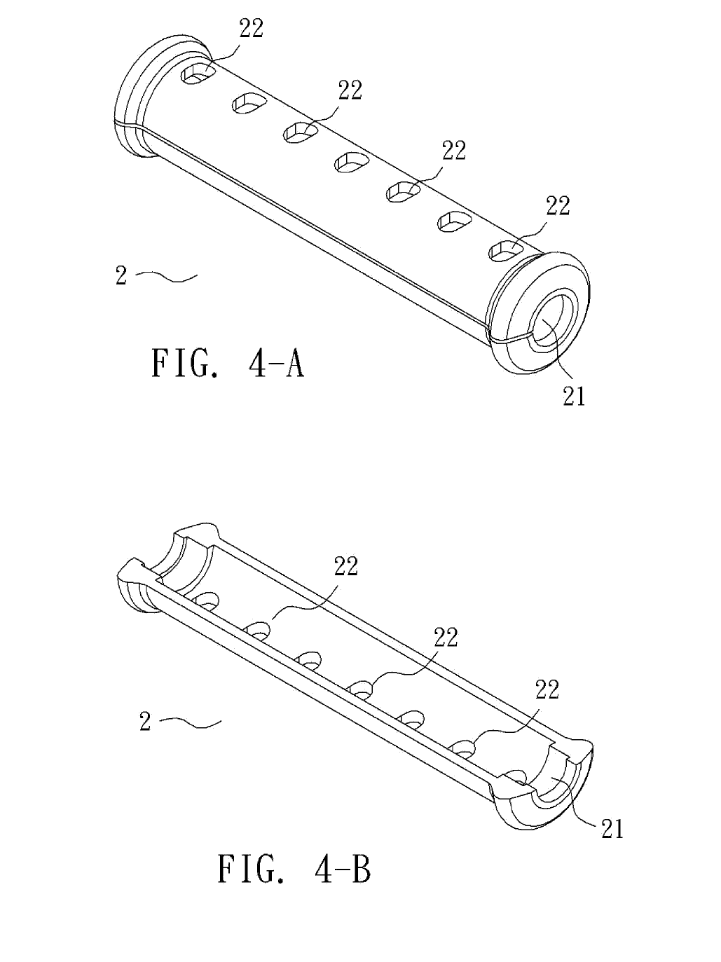

With reference to FIGS. 3A, 3B, 4A and 4B for a protecting cover for a bicycle control line in accordance with the present invention, the protecting cover comprises an inner capsule 1 and an outer capsule 2 covered onto control lines B (such as the brake and speed change control lines) at a same section of a bicycle body A, wherein the inner capsule 1 is made of a hard plastic material and in the form of a hollow passage 11, and includes a plurality of protrusions 12 disposed on an external circumferential surface of the inner capsule 1, and the outer capsule 2 is made of a soft material and in the form of a hollow passage 21, and includes a plurality of penetrating holes 22 having a corresponding shape of the protrusions 12 and disposed at positions corresponding to the protrusions 12 on an external circumferential surface of the inner capsule 1.

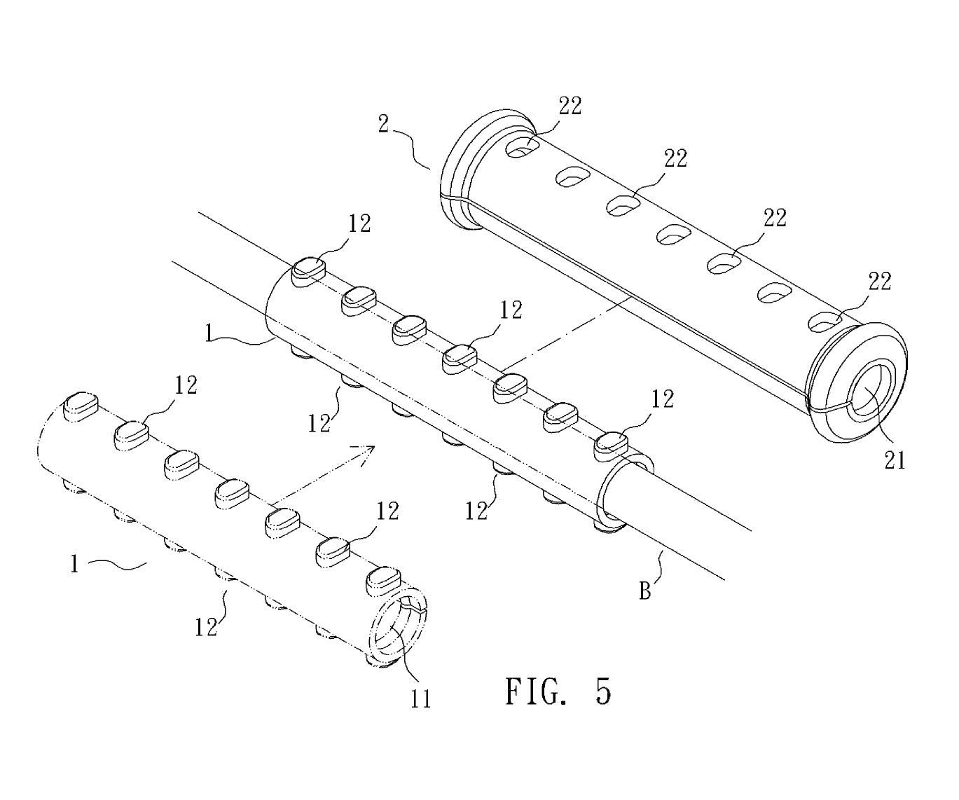

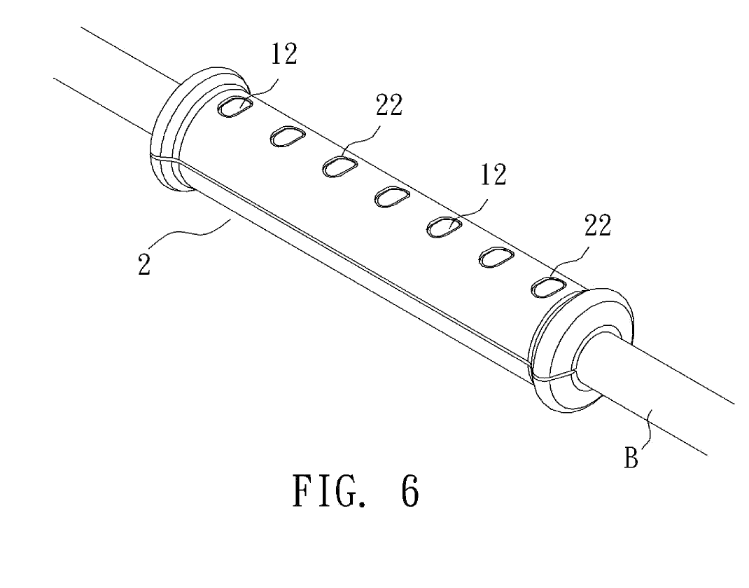

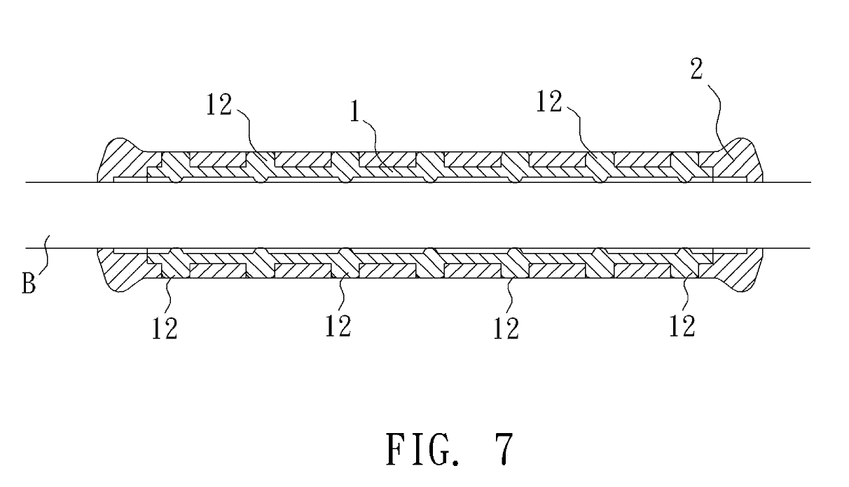

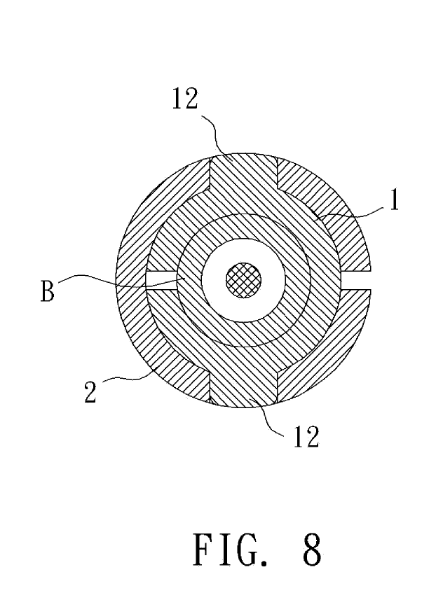

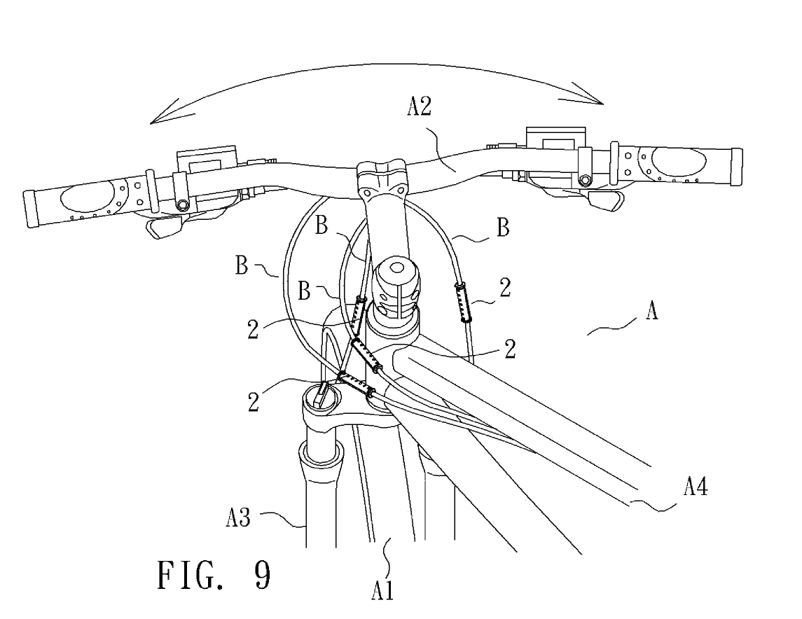

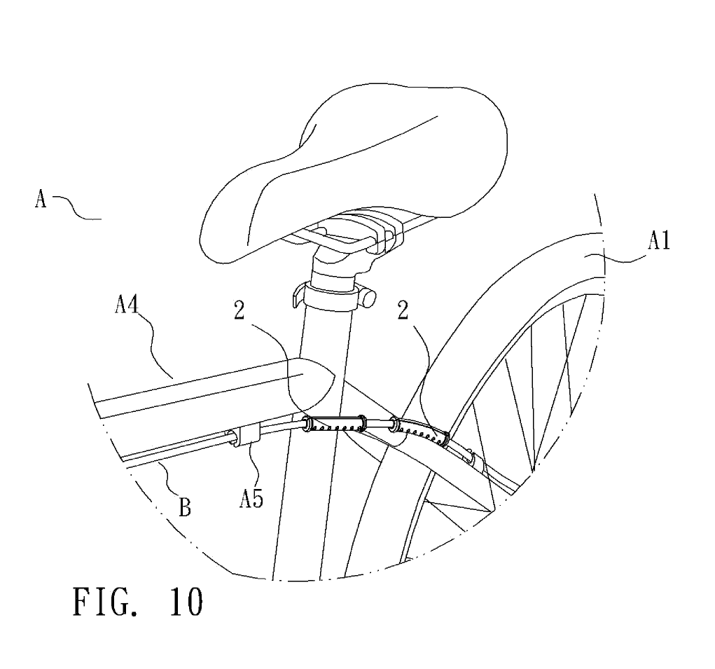

The hollow passage 11 in the inner capsule 1 is provided for covering the control line B at the section (as shown in FIG. 5) where the bicycle body A is in contact with the control line B (as shown in FIGS. 9 and 10), and then the hollow passage 21 of the flexible outer capsule 2 is provided for wrapping the inner capsule 1 (as shown in FIG. 6), such that the protrusions 12 on the external surface of the inner capsule 1 can be embedded into the penetrating holes 22 of the outer capsule 2 for positioning the protecting cover (as shown in FIGS. 7 and 8). With the flexible effect of the outer capsule 2, the protecting cover can prevent the bicycle body A from being scratched or damaged by the contact of the control lines.

In summation of the description above, the present invention improves over the prior art and complies with the patent application requirements, and thus is duly filed for patent application.

What is claimed is:

1. A protecting cover for a bicycle control line, comprising an inner capsule and an outer capsule, and the inner capsule being made of a hard plastic material and in a hollow passage form, and a plurality of protrusions being formed on an external circumferential surface of the inner capsule, and the outer capsule being made of a soft material and in a hollow passage form, and a plurality of penetrating holes having a corresponding shape with the protrusions, and disposed on an external circumferential surface of the outer capsule and at positions corresponding to the protrusion disposed on the external circumferential surface of the inner capsule, such that in a section where a bicycle body is in contact with the control line, the inner capsule wraps the control line of the section, and then a flexible outer capsule covers the inner capsule, and the protrusions on an external surface of the inner capsule are embedded into the penetrating holes of the outer capsule for positioning the control line, so as to achieve the effect of protecting the bicycle body from being scratched or damaged by the contact of the control line.
